(19) United States
(12) Patent Application Publication
(10) Pub. No.: US 2026/0086752 A1
(43) Pub. Date: Mar. 26, 2026

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: KAZUKI KADO, Kanagawa (JP)

(21) Appl. No.: 19/331,258

(22) Filed: Sep. 17, 2025

(30) Foreign Application Priority Data
Sep. 20, 2024 (JP) 2024-164393

(51) Int. Cl. G06F 3/14; G06F 3/04847

(52) U.S. Cl. CPC G06F 3/14; G06F 3/04847

(57) ABSTRACT

An information processing apparatus includes: a first display control unit configured to perform control to display a first screen and a second screen arranged so as to overlap with the first screen on a display unit; an obtaining unit configured to obtain information representing a size of a region of the first screen that does not overlap with the second screen, in a case where the second screen is displayed by the first display control unit; a second display control unit configured to perform control to display a first object for closing the second screen, in a case where the information satisfies a predetermined condition; and a control unit configured to perform control to close the second screen, in a case where the first object displayed by the second display control unit is operated by a user.

### BACKGROUND

### Field of the Technology

The present disclosure relates to an information processing apparatus, a control method of an information processing apparatus, and a storage medium.

### Description of the Related Art

Some information processing apparatuses are known to have a function of closing a screen by operating a region outside the frame of the screen, instead of pressing a close button displayed on the screen.

As a technology related to screen operation, a literature (Japanese Patent Laid-Open No. 2007-304809) discloses a technology for controlling the display of a button for confirming settings selected by a user on a setting screen of an image processing apparatus in accordance with the user's level of proficiency in operation.

There is a demand for improvement of usability in screen operation.

### SUMMARY

The information processing apparatus according to an embodiment of the present disclosure is characterized by including: a first display control unit configured to perform control to display a first screen and a second screen arranged so as to overlap with the first screen on a display unit; an obtaining unit configured to obtain information representing a size of a region of the first screen that does not overlap with the second screen, in a case where the second screen is displayed by the first display control unit; a second display control unit configured to perform control to display a first object for closing the second screen, in a case where the information satisfies a predetermined condition; and a control unit configured to perform control to close the second screen, in a case where the first object displayed by the second display control unit is operated by a user.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of the hardware configuration of an image processing apparatus.

FIG. 2 is a diagram illustrating an example of the software configuration of the image processing apparatus.

FIG. 3 is a diagram illustrating an example of the configuration of a display operation unit.

FIG. 4 is a diagram illustrating an example of a setting screen displayed on the display operation unit.

FIG. 5 is a flowchart illustrating an example of the processing performed in a case where a child screen is displayed.

FIG. 6 is a diagram illustrating an example of a setting screen.

FIG. 7 is a diagram illustrating an example of a setting screen.

FIG. 8 is a flowchart illustrating an example of the processing performed in a case where the screen layout is changed while a child screen is displayed.

FIG. 9 is a diagram illustrating an example of a setting screen that is enlarged and displayed.

FIG. 10 is a diagram illustrating an example of a setting screen that is enlarged and displayed.

FIG. 11 is a diagram illustrating an example of a setting screen that is enlarged and displayed.

FIG. 12 is a diagram illustrating an example of a setting screen that is enlarged and displayed.

FIG. 13 is a diagram describing a method for obtaining an outer-frame region.

FIG. 14 is a diagram describing a method for obtaining an outer-frame region.

FIG. 15 is a diagram describing a method for obtaining an outer-frame region.

FIG. 16 is a diagram illustrating an example of a setting screen on which a threshold value of a reaction region can be set.

FIG. 17 is a diagram illustrating an example of a setting screen on which a threshold value of a reaction region can be set.

FIG. 18 is a diagram illustrating an example of a setting screen on which a threshold value of a reaction region can be set.

### DESCRIPTION OF THE EMBODIMENTS

Hereinafter, a detailed description is given of preferable embodiments of the present disclosure with reference to the accompanying drawings. Note that the following embodiments are not intended to limit the contents of the present disclosure, and all of the combinations of the characteristics described in the following embodiments are not necessarily essential to the solutions provided in the present disclosure. Note that the same reference sign is given for descriptions of the same configuration.

Some information processing apparatuses are known to have a function of closing a displayed screen in a case where a user operates the region outside the frame of the screen. In such an information processing apparatus, in a case where the region outside the frame of a displayed screen is narrow, it is assumed that a situation may occur in which a user presses an unintended button or cannot close the screen. Even with a use of the technology for controlling the display of a button for confirming settings selected by a user in accordance with the user's level of proficiency in operation, the situation may still occur in which the user performs an erroneous operation or cannot close the screen. Hereinafter, a description is given, using an image processing apparatus as an example of an information processing apparatus capable of avoiding such a situation and improving usability in screen operation.

### First Embodiment

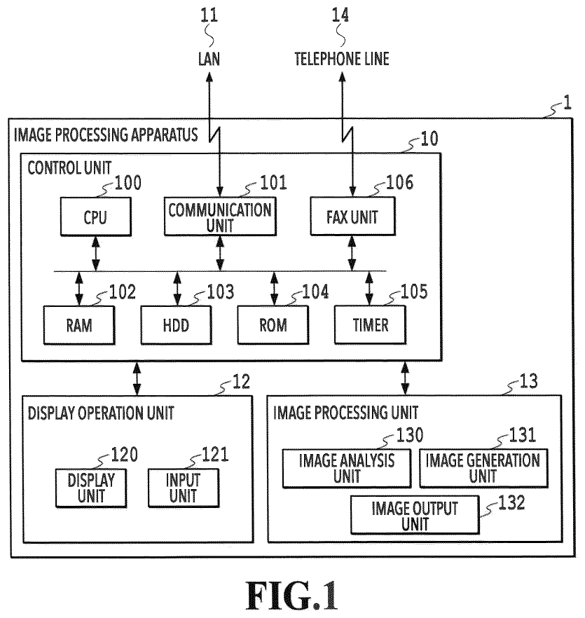

FIG. 1 is a block diagram illustrating an example of the hardware configuration of the image processing apparatus 1 according to the present embodiment. The configuration of the image processing apparatus 1 is described with reference to FIG. 1. Note that, hereinafter, a description is given using the image processing apparatus 1 as an example of a type of information processing apparatus.

The image processing apparatus 1 includes the control unit 10, the display operation unit 12, and the image processing unit 13. The control unit 10 controls the operation of each unit of the image processing apparatus 1. The control unit 10 includes the CPU 100, the communication unit 101, the RAM 102, the HDD 103, the ROM 104, the timer 105, and the fax unit 106. The communication unit 101 is communicably connected to the LAN 11 by wireless or wired communication. The fax unit 106 is communicably connected to the telephone line 14 by wireless or wired communication.

The CPU 100 controls the image processing apparatus 1. The LAN 11 is a network for the image processing apparatus 1 to exchange data with an external apparatus. The image processing apparatus 1 is connected to the Internet via the LAN 11. The communication unit 101 transmits and receives data via the LAN 11.

The RAM 102 is a main storage memory of the image processing apparatus 1, and is used as a system work memory for the operation of the CPU 100. The HDD 103 is a hard disk drive. The HDD 103 may be a storage device such as, for example, a magnetic disk, an optical medium, or a flash memory, or may be a combination of these. The HDD 103 is capable of storing job data, setting data, and the like. Note that the HDD 103 does not have to be present in the image processing apparatus 1. For example, the image processing apparatus 1 may utilize an external server, a personal computer, or the like, as a storage device via the communication unit 101.

The ROM 104 is a boot ROM, and stores a boot program for the system of the image processing apparatus 1 and various control programs. The CPU 100 implements various types of control by loading a program stored in the ROM 104 into the RAM 102 and executing the loaded program.

The timer 105 measures time in accordance with an instruction from the CPU 100, and notifies the CPU 100 by an interrupt or the like in a case where the designated time has elapsed. The fax unit 106 transmits and receives fax data via the telephone line 14.

The display operation unit 12 is controlled by the control unit 10, and includes the display unit 120 and the input unit 121. The display unit 120 includes a display for displaying various data, predetermined notifications, and various screens to the user. The input unit 121 accepts input from a user via interfaces such as, for example, a touch panel, a mouse, a camera, voice input, and a keyboard.

The image processing unit 13 is controlled by the control unit 10, and includes the image analysis unit 130, the image generation unit 131, and the image output unit 132.

The image analysis unit 130 analyzes the structure of an original document image and extracts necessary information from the analysis results. The image generation unit 131 reads an original document using a reading unit (not illustrated in the drawings), thereby digitizing the image of the original document to generate image data, and stores the image data in the HDD 103. Further, the image generation unit 131 is also capable of generating image data of the original document in a different format using information analyzed by the image analysis unit 130.

The image output unit 132 outputs image data stored in the HDD 103 or the like. As an example of this output method, the image output unit 132 may print image data of an original document on paper, or may transmit the image data to an external device, a server, or a facsimile device connected to a network via the communication unit 101. Further, as the output method, the image output unit 132 may store the image data in a storage device connected to the image processing apparatus 1.

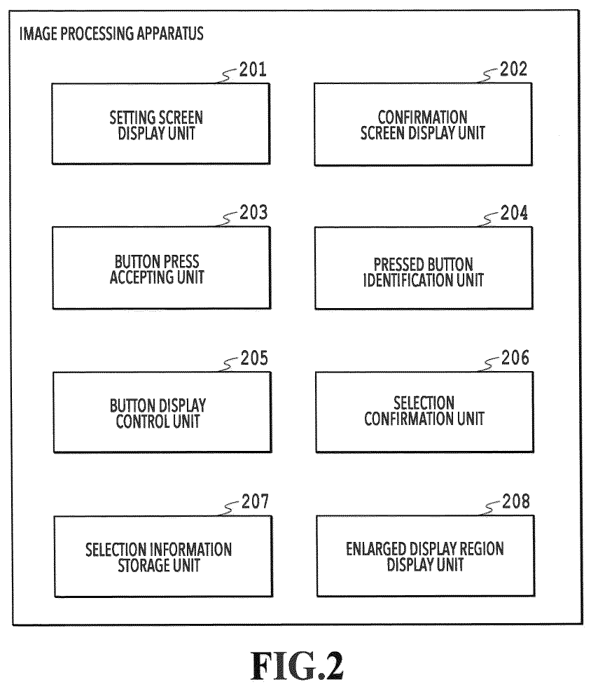

FIG. 2 is a diagram illustrating an example of the software configuration of the image processing apparatus 1. The software configuration of the image processing apparatus 1 is described with reference to FIG. 2.

The image processing apparatus 1 has, as its functions, the setting screen display unit 201, the confirmation screen display unit 202, the button press accepting unit 203, the pressed button identification unit 204, the button display control unit 205, the selection confirmation unit 206, the selection information storage unit 207, and the enlarged display region display unit 208. Each of these functional units is implemented by the CPU 100 loading a program stored in the HDD 103 into the RAM 102 and executing the program. That is, these functional units are functions of software that is stored in the HDD 103 and that operates on an operating system (OS) started by a boot program stored in the ROM 104.

The setting screen display unit 201 performs a process of displaying a setting screen on which print settings can be made, and a process of closing the setting screen, for example. The setting screen in the present embodiment includes the later-described copy basic screen 401, and a child screen associated with the copy basic screen.

The setting screen, which is displayed under control of the setting screen display unit 201, is a setting screen that displays a plurality of setting values for setting items and allows the setting of setting values for the setting items by accepting a user's selection operation on the displayed setting values.

The confirmation screen display unit 202 displays a screen for allowing the user to confirm whether to close the setting screen in a case where the user presses the button to close the setting screen without confirming the selection that has been changed on the setting screen.

The button press accepting unit 203 detects pressing of a button by the user. The pressed button identification unit 204 identifies the button pressed by the user, and identifies the setting screen associated with that button. Note that, in the present embodiment, a button refers to an operator that is displayed on the display unit 120 and accepts a predetermined instruction through a user's operation. Further, buttons may be referred to as software keys.

The button display control unit 205 determines whether or not to display a button for closing a child screen. Note that the button display control unit 205 may determine whether or not to display an OK button as a button for confirming a user's selection on a setting screen.

The selection confirmation unit 206 confirms a selection through a user's operation on a setting screen. For example, in a case where an OK button is displayed by the button display control unit 205, the selection confirmation unit 206 confirms a selection in response to the OK button being pressed by the user. Further, in a case where an OK button is not displayed by the button display control unit 205, the selection confirmation unit 206 confirms the selection of a setting value for a setting item in response to the setting value being selected by a user's operation.

The selection information storage unit 207 stores the options being selected on a setting screen. Note that, at the time of transition to a setting screen, the selection information storage unit 207 is assumed to store initial values.

The enlarged display region display unit 208 performs processing for displaying the later-described enlarged display region. Further, the enlarged display region display unit 208 determines whether or not to display the enlarged display region. For example, in a case where a pinch-out operation (an operation of spreading two fingers apart to widen the interval) is performed by the user, the enlarged display region display unit 208 determines that the screen layout has been changed, and displays the enlarged display region. Then, in accordance with the degree of the pinch-out, the enlarged display region display unit 208 enlarges and displays objects such as character strings and buttons that constitute the screen.

Further, also in a case where a pinch-in operation (an operation of pinching two fingers together to narrow the interval) is performed, the enlarged display region display unit 208 determines that the screen layout has been changed. Furthermore, the enlarged display region display unit 208 performs the control to move the enlarged display region in response to a user's operation. A detailed description is given of these later.

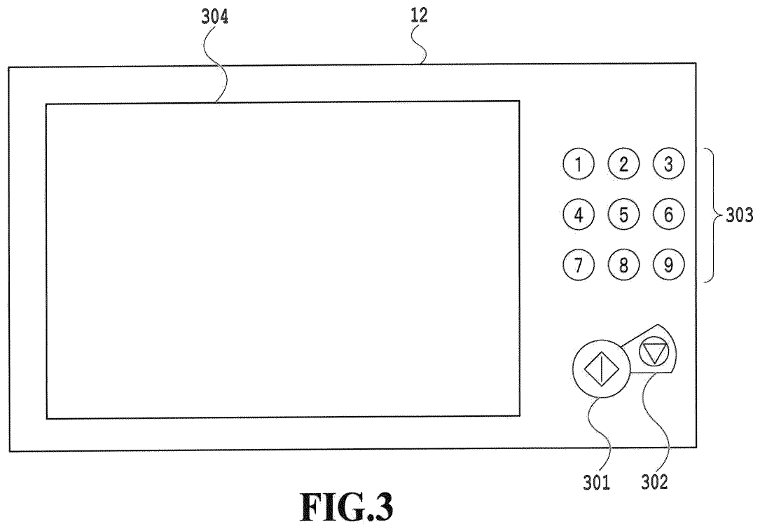

FIG. 3 is a diagram illustrating an example of the configuration of the display operation unit 12 illustrated in FIG. 1. The display operation unit 12 includes the start key 301, the clear/stop key 302, the numeric keypad 303, and the screen display region 304.

The start key 301 is a key that accepts, from the user, an instruction to execute printing by the image processing unit 13 and the control unit 10. The clear/stop key 302 functions as a clear key in a case where the image processing apparatus 1 is in an idling state. The clear key is a key for accepting cancellation of input such as texts and numbers by the user. Further, the clear/stop key 302 functions as a stop key in a case where the image processing apparatus 1 is in the state of executing a job. The stop key is a key that accepts cancellation of a job being executed.

The numeric keypad 303 is a set of keys that accept input of numbers. The screen display region 304 is a region that displays a screen for making various settings in a case of executing copying, fax transmission, or the like on the image processing apparatus 1. Note that the start key 301, the clear/stop key 302, and the numeric keypad 303 may be configured as software keys displayed in the screen display region 304.

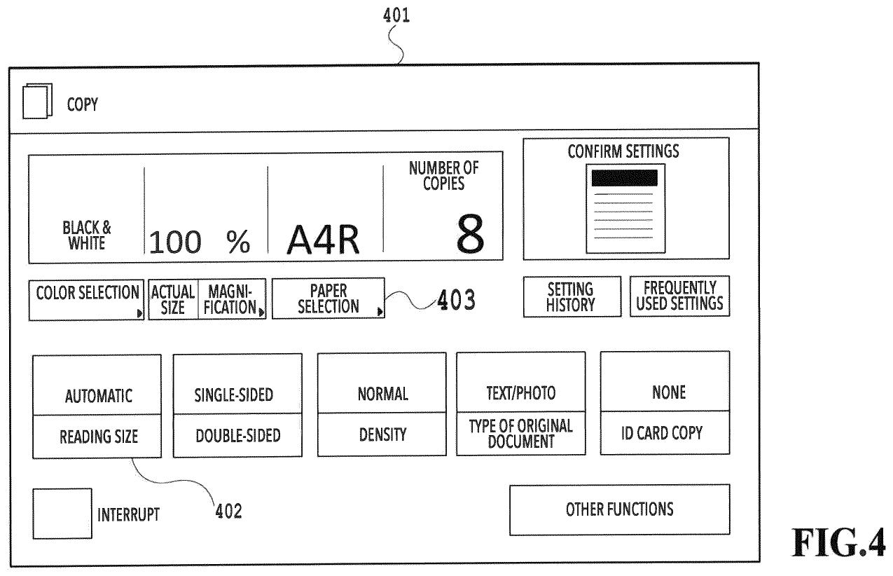

FIG. 4 is a diagram illustrating an example of the copy basic screen 401 displayed in the screen display region 304. The copy basic screen 401 has the reading size setting button 402, the paper selection button 403, etc. Through the copy basic screen 401, the user can make settings related to copying, such as selecting a cassette in which recording media are loaded and changing the magnification of an image to be printed.

If the user presses the reading size setting button 402, a screen Is displayed on which the reading size of the original document to be scanned can be set. If the user presses the paper selection button 403, a screen is displayed on which the paper to be used for printing can be set.

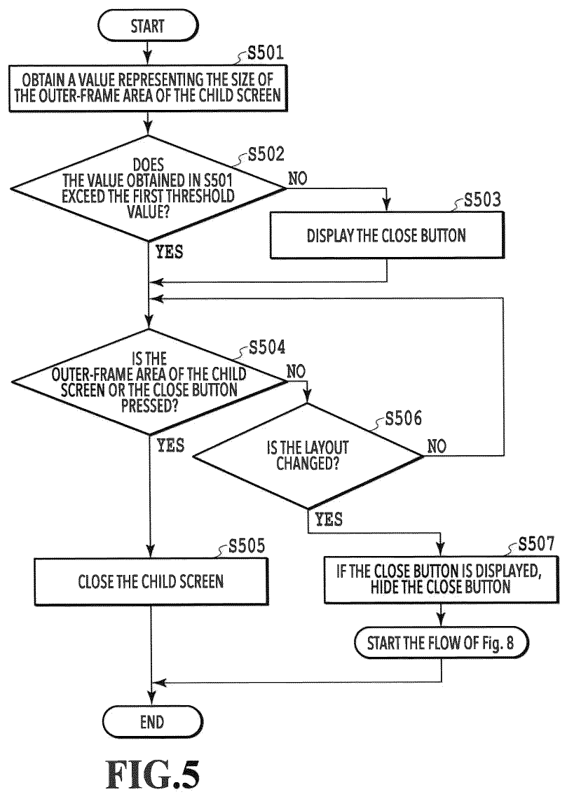

FIG. 5 is a flowchart illustrating an example of processing executed by the CPU 100 as a function of the software illustrated in FIG. 2 in a case where a child screen, such as the later-described reading size setting screen 601 or paper selection screen 701, is displayed on the copy basic screen 401.

Each process in the flowchart illustrated in FIG. 5 is implemented by the CPU 100 of the image processing apparatus 1 reading out a program stored in the ROM 104 into the RAM 102 and executing it. By executing a program called from the ROM 104, each of the functional units in FIG. 2 functions. Note that part or all of the functions in the steps of FIG. 5 may be implemented by hardware such as an ASIC or an electronic circuit. The symbol “S” in the description of each process indicates that it is a step in the flowchart diagram (the same applies hereinafter to the flowchart diagrams of the present specification).

Further, the flowchart illustrated in FIG. 5 is started in response to a detection by the CPU 100 that a child screen has been displayed on the screen displayed in the screen display region 304.

Before describing the details of the flows of the flowchart illustrated in FIG. 5, a description is given about the reading size setting screen 601 and the paper selection screen 701.

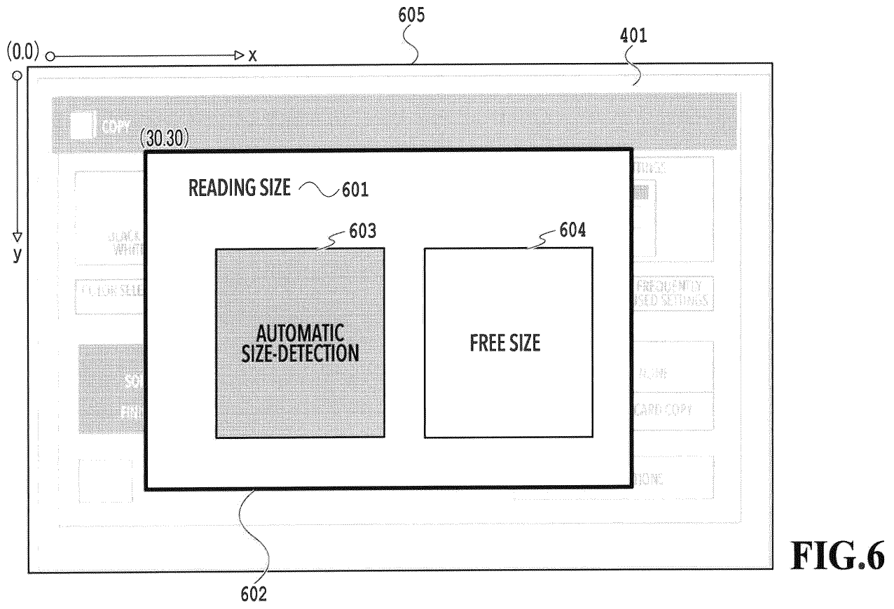

First, the reading size setting screen 601 is described. FIG. 6 is a diagram illustrating an example of the reading size setting screen 601 in the present embodiment. The reading size setting screen 601 is a screen displayed on the child screen region 602. The image processing apparatus 1 displays the reading size setting screen 601 on the copy basic screen 401 such that the reading size setting screen 601 is embedded within the copy basic screen 401. The reading size setting screen 601 is provided with the automatic size-detection setting button 603 and the free size setting button 604.

Upon detecting that the reading size setting button 402 on the copy basic screen 401 is pressed by the user, the image processing apparatus 1 displays the reading size setting screen 601. The reading size setting screen 601 is a first child screen of the copy basic screen 401 and is displayed so as to overlap with the copy basic screen 401. To emphasize the overlap of the screens, in a case where the reading size setting screen 601 is displayed on the copy basic screen 401, the portion of the copy basic screen 401 that does not overlap with the reading size setting screen 601 may be shaded, as illustrated in FIG. 6.

The child screen region 602 is a region in which the reading size setting screen 601 is displayed. The child screen region 602 is defined by parameters such as an upper left X coordinate, an upper left Y coordinate, a height H, and a width W based on coordinate axes in which the upper left vertex of the later-described parent screen region 605 is set as the reference point (X coordinate=0, Y coordinate=0).

If the child screen region 602 is uniquely determined, the region can be defined based on the above-described coordinate axes. For example, in a case where the child screen region 602 is a rectangle, the region can be defined by an upper left X coordinate, an upper left Y coordinate, a lower right X coordinate, and a lower right Y coordinate. The parent screen region 605 is a region in which the copy basic screen 401 is displayed, and is defined based on the above-described coordinate axes.

The automatic size-detection setting button 603 is a setting button for setting “AUTOMATIC SIZE-DETECTION” for the reading size setting button 402. If “AUTOMATIC SIZE-DETECTION” is set, the original document size is automatically detected, and the detected original document size is set as the reading size.

The free size setting button 604 is a setting button for setting “FREE SIZE” for the reading size setting button 402. If “FREE SIZE” is set, the original document is to be read in free size.

If the setting value that is set for the reading size setting button 402 is a value indicating “AUTOMATIC SIZE-DETECTION,” the image processing apparatus 1 may display the automatic size-detection setting button 603 in a shaded manner as illustrated in FIG. 6, thereby indicating that automatic size-detection is currently set.

In a case where the automatic size-detection setting button 603 or the free size setting button 604 is pressed, the image processing apparatus 1 updates the setting of the reading size setting button 402 to the setting corresponding to the pressed button, and closes the reading size setting screen 601. The set contents are saved in the HDD 103 or the RAM 102 by the CPU 100.

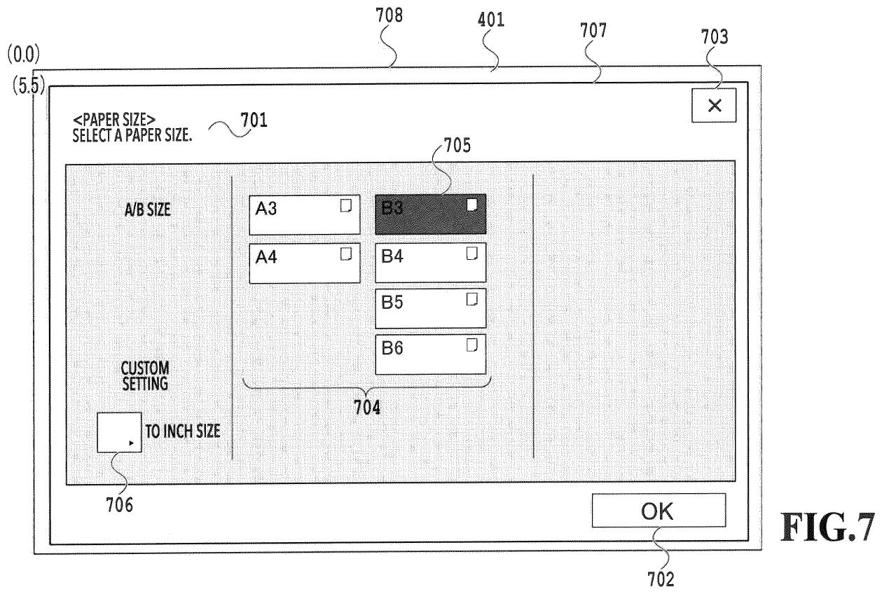

Next, the paper selection screen 701 is described. FIG. 7 is a diagram illustrating an example of the paper selection screen 701 in the present embodiment. The paper selection screen 701 is a screen that is displayed on the child screen region 707. The image processing apparatus 1 displays the paper selection screen 701 on the copy basic screen 401 such that the paper selection screen 701 is embedded within the copy basic screen 401. The paper selection screen 701 is provided with the OK button 702, the close button 703, the paper size button group 704, and the inch size switching button 706.

Upon detecting that the paper selection button 403 on the copy basic screen 401 is pressed by the user, the image processing apparatus 1 displays the paper selection screen 701. The paper selection screen 701 is a second child screen of the copy basic screen 401 and is displayed so as to overlap with the copy basic screen 401. The parent screen region 708 is a region where the copy basic screen 401 is displayed. The child screen region 707 and the parent screen region 708 are defined based on the above-described coordinate axes.

The user can perform settings related to the recording medium to be used for printing via the paper selection screen 701. If the OK button 702 is pressed by the user, the image processing apparatus 1 confirms the contents that are set on the paper selection screen 701. The confirmed contents are saved in the HDD 103 or the RAM 102 by the CPU 100. Thereafter, the paper selection screen 701 is closed.

The user can set the paper size by selecting one of the paper size setting buttons that constitute the paper size button group 704. The paper size button group 704 includes paper size setting buttons that respectively enable setting of A3, A4, A5, B3, B4, B5, and B6, which are examples of sizes of recording media used for printing.

Further, in accordance with the size of the recording medium being set, the image processing apparatus 1 may display the paper size setting button corresponding to the size of the recording medium in a shaded or highlighted manner. For example, if B3 is set as the size of the recording medium used for printing, the paper size setting button 705 corresponding to B3 is displayed in a shaded manner as illustrated in FIG. 7.

By pressing the inch size switching button 706, the user can change the sizes of the recording medium that can be set using paper size setting buttons of the paper size button group 704 from the A/B system to the inch system.

For example, in a case where a child screen of the copy basic screen 401, such as the reading size setting screen 601 or the paper selection screen 701, is displayed by a user operation, the flowchart illustrated in FIG. 5 is started. Next, the flow of the flowchart illustrated in FIG. 5 is described in detail.

In S501, the CPU 100 obtains information representing the size of the portion of the parent screen that does not overlap with the child screen displayed on the parent screen (hereinafter referred to as the outer-frame region of the child screen). As the information representing the size of the outer-frame region of the child screen, a value indicating a distance or a value indicating an area can be adopted. In the present embodiment, an example is described in which the CPU 100 derives and obtains the distance from the frame of the parent screen to the frame of the child screen, as a value representing the size of the outer-frame region of the child screen. Note that, in the present embodiment, the boundary line that separates a predetermined screen from the region outside that screen is referred to as the frame of the screen. Further, the boundary line that separates a predetermined region from the region outside that region is referred to as the frame of the region.

For example, if the upper left vertex of the parent screen is (x1, y1) and the upper left vertex of the child screen is (x2, y2), the CPU 100 can calculate and obtain the distance D from the frame of the parent screen to the frame of the child screen using the following formula 1.

$$Distance D = \{ \begin{matrix}\sqrt{{( {x}_{2} - {x}_{1} )}^{2} + {( {y}_{2} - {y}_{1} )}^{2} ,} & if {x}_{2} - {x}_{1} > 0 and {y}_{2} - {y}_{1} > 0 \\ 0 , & otherwise\end{matrix} \qquad [ Formula 1 ]$$

In S502, the CPU 100 determines whether or not the information indicating the distance from the frame of the parent screen to the frame of the child screen, which is obtained in S501, satisfies a predetermined condition. Specifically, whether or not the value indicating the distance from the frame of the parent screen to the frame of the child screen exceeds the first threshold value is determined. If the CPU 100 determines that the value indicating the distance obtained in S501 exceeds the first threshold value (YES in S502), it is determined that the outer-frame region of the child screen is wide, and the processing proceeds to S504.

If the CPU 100 determines that the value indicating the distance obtained in S501 is within the first threshold value (NO in S502), it is determined that the outer-frame region of the child screen is narrow, and the processing proceeds to S503.

In a situation where a child screen is displayed, if the user wishes to close the displayed child screen, the user needs to perform an operation of pressing the outer-frame region of the child screen. The CPU 100 performs acceptance control to accept an instruction to close the child screen from the user via the outer-frame region of the child screen.

Here, it is assumed that the minimum region that the user can tap on, which is defined by the above-described coordinate axes, is a square of 10 [MM]×10 [MM]. [MM] indicates the unit of physical display length of the screen per coordinate. In this case, at the time of determining whether the outer-frame region of the child screen is wide or narrow, the CPU 100 determines whether the value indicating the distance from the frame of the parent screen to the frame of the child screen exceeds 14, which is the value indicating the length of the diagonal line of that square. In other words, in a case where the minimum region that a user can tap on is defined as a 10 mm×10 mm square, the CPU 100 uses 14 as the first threshold value at the time of determining in S502 whether the outer-frame region of the child screen is wide or narrow. That is, whether the outer-frame region of the child screen is wide or narrow can be rephrased as whether the user is able to press the outer-frame region of the child screen to close the child screen.

In the description of the present embodiment, unless otherwise specified regarding a method for closing a child screen, the CPU 100 controls so as to provide the user with either a method of closing a child screen by pressing a close button or a method of closing a child screen by pressing the outer-frame region of the child screen, as an example. Specifically, in a situation where a close button is displayed, the CPU 100 does not perform the control of closing the child screen in response to a user's pressing operation on the outer-frame region of the child screen.

On the other hand, in a situation where a close button is not displayed, the CPU 100 performs the control of closing the child screen in response to a user's pressing operation on the outer-frame region of the child screen.

Note that the minimum region that the user can tap on need not be used as a threshold value for determining whether the outer-frame region of a child screen is wide or narrow. That is, the first threshold value used in S502 may be any desired value other than a value corresponding to the minimum region that the user can tap on.

As illustrated in FIG. 6, a case is assumed in which the reading size setting screen 601, which is a first child screen, is displayed on the copy basic screen 401, which is a parent screen. The coordinates (X coordinate: Y coordinate) of the upper left vertex of the parent screen region 605 are (0, 0), and the coordinates of the upper left vertex of the child screen region 602 are (30, 30). That is, from the above-described formula 1, the distance D is derived to be about 42.

$$\sqrt{{( 30 - 0 )}^{2} + {( 30 - 0 )}^{2}} = 42.4264$$

In this case, since 42 [MM]>14 [MM], the CPU 100 determines in S502 that the outer-frame region of the child screen is wide, and the processing proceeds to S504.

As illustrated in FIG. 7, a case is assumed in which the paper selection screen 701, which is a second child screen, is displayed on the copy basic screen 401, which is a parent screen. The coordinates (X coordinate: Y coordinate) of the upper left vertex of the parent screen region 708 are (0, 0), and the coordinates of the upper left vertex of the child screen region 707 are (5, 5). That is, from the above-described formula 1, the distance D is derived to be about 7.

$$\sqrt{{( 5 - 0 )}^{2} + {( 5 - 0 )}^{2}} = 7.071$$

In this case, since 7 [MM]<14 [MM], the CPU 100 determines in S502 that the outer-frame region of the child screen is narrow, and the processing proceeds to S503.

In S503, the CPU 100 displays a close button for accepting an instruction to close the child screen. For example, as illustrated in FIG. 7, the CPU 100 displays the close button 703 in the upper right portion of the paper selection screen 701. In the present embodiment, an example is described in which the display position of the close button 703 on the paper selection screen 701 is fixed as illustrated in FIG. 7. Note that the close button 703 need not be displayed at a fixed position, but may be displayed at any desired position. For example, the close button 703 may be displayed at a position that is not close to other objects provided on the child screen. A position that is not close to other objects is, for example, a position that is a certain distance or more away from the OK button 702, the paper size button group 704, and the inch size switching button 706 provided on the paper selection screen 701, as illustrated in FIG. 7.

In S504, the CPU 100 determines whether or not the outer-frame region of the child screen or the close button 703 is pressed. If the CPU 100 determines that the outer-frame region of the child screen or the close button 703 is pressed (YES), the processing proceeds to S505, where the child screen is closed, and the flow illustrated in FIG. 5 ends.

In S504, if the CPU 100 determines that the outer-frame region of the child screen or the close button 703 is not pressed (NO), the processing proceeds to S506.

In S506, the CPU 100 determines whether or not the screen layout is changed. If the CPU 100 determines that the screen layout is changed (YES), the processing proceeds to S507, and if the CPU 100 determines that the screen layout is not changed (NO), the processing proceeds to S504.

Note that, in the present embodiment, changing the screen layout refers to a case where an enlarged display region is displayed, a case where a displayed enlarged display region is enlarged or reduced in size with respect to the parent screen region, or a case where an enlarged display region is moved in the parent screen region. In other words, changing the screen layout refers to a case where the display magnification of the parent screen displayed in the parent screen region or the child screen displayed in the child screen region is changed. Alternatively, changing the screen layout refers to a case where an enlarged display region is moved in the parent screen while maintaining a state in which its display magnification is greater than the actual size.

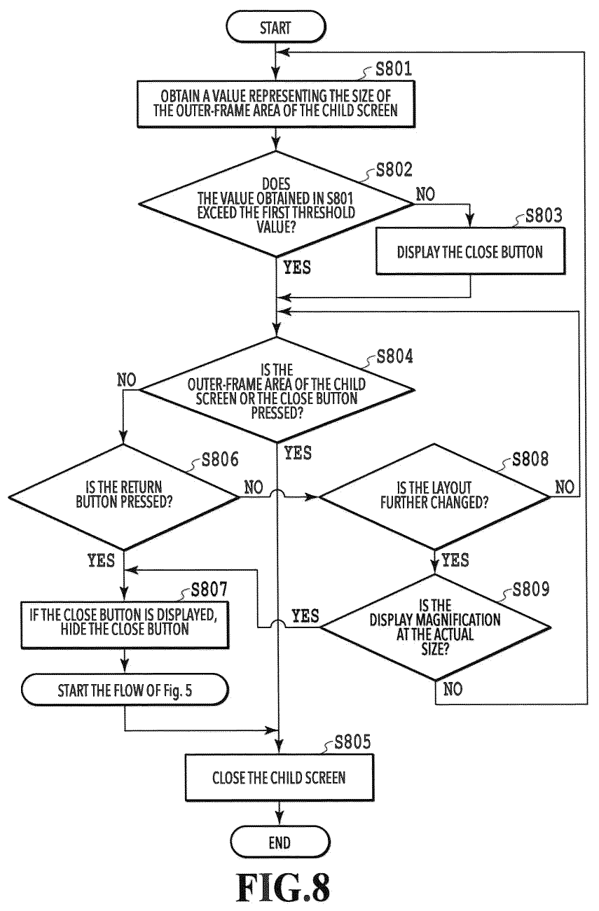

In S507, if the close button was displayed in S503, the CPU 100 performs the control to hide the close button, starts the later-described flow illustrated in FIG. 8, and ends the flow illustrated in FIG. 5. If it is necessary to display the close button due to a change in the screen layout, the CPU 100 performs the control to display the close button according to the flow illustrated in FIG. 8.

Next, a case where the screen layout is changed while the child screen is displayed is described. In a web browser or tablet terminal, it is possible to change the display region of a screen displayed thereon. In the present embodiment, an example is described in which the image processing apparatus 1 also has a function of enlarging part of a screen in order to improve usability. Referring to FIG. 8, a description is given about processing to be executed by CPU 100 in a case where the screen layout is changed while a parent screen and a child screen are displayed on the display operation unit 12 of the image processing apparatus 1 that has such a function.

FIG. 8 is a flowchart illustrating an example of processing to be executed by the CPU 100 as a function of the software illustrated in FIG. 2, taking as an example a case where the screen layout is changed by the user while the reading size setting screen 601 is displayed on the copy basic screen 401.

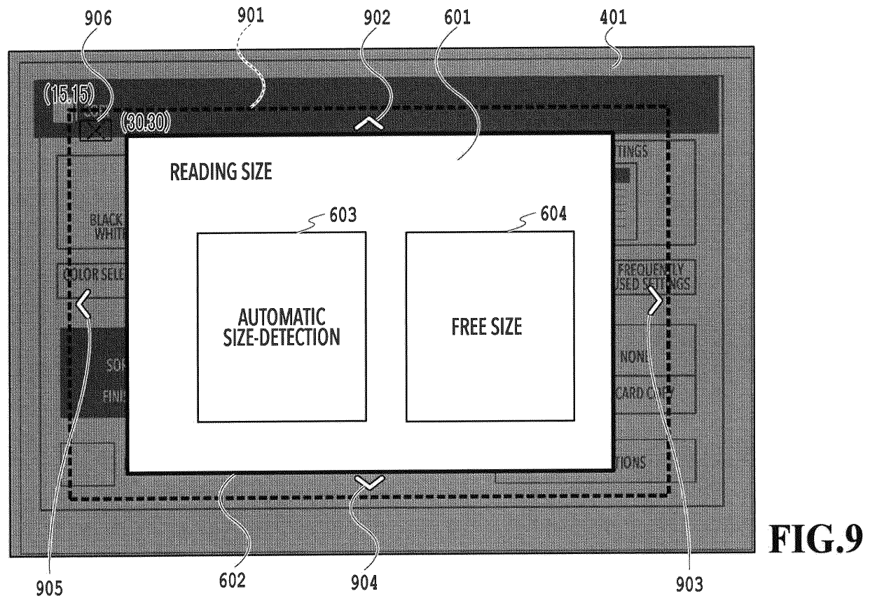

Before describing the processing of the CPU 100 in a case where the screen layout is changed while a child screen is displayed, a description is given with reference to FIG. 9 to FIG. 12 about specific examples of a change in the screen layout in the present embodiment.

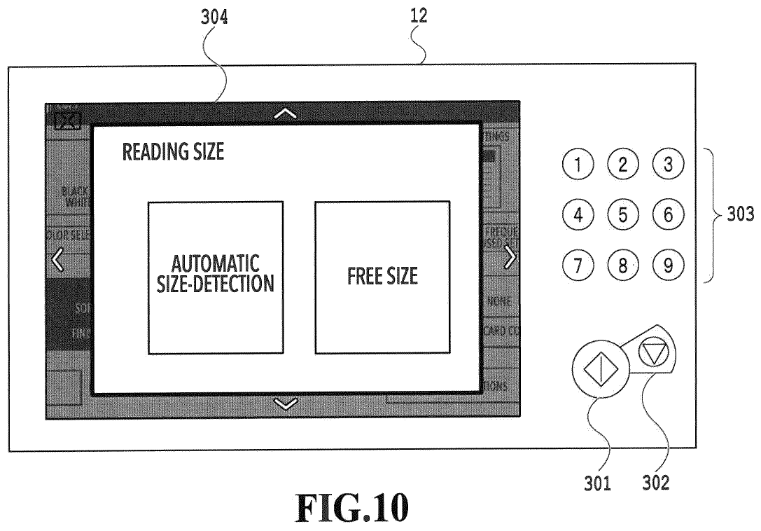

FIG. 9 and FIG. 10 illustrate an example of a case where, while the reading size setting screen 601 is displayed as the first child screen of the copy basic screen 401, the layout of these screens displayed on the display operation unit 12 is changed by the screen enlargement function that the image processing apparatus 1 has.

In a case where a pinch-out operation is performed by the user on the screen display region 304, the image processing apparatus 1 changes the layout of the screens displayed in screen display region 304 using the screen enlargement function.

If a pinch-out operation is performed by the user while the reading size setting screen 601 is displayed on the copy basic screen 401, objects such as texts and buttons displayed in the enlarged display region are enlarged and displayed by the screen enlargement function. The enlarged display region in the present embodiment is a region that can be visually recognized by the user as a part of the parent screen region in a case where the display magnification of the parent screen and the child screen is changed by the screen enlargement function. That is, as the user performs a pinch-out operation, the region that can be visually recognized by the user narrows, and at the same time, the objects displayed within the enlarged display region are enlarged and displayed.

Further, the enlarged display region is defined by its coordinates relative to the parent screen region. For example, FIG. 9 illustrates an example of an enlarged display region. The enlarged display region 901 illustrated in FIG. 9 is a rectangle similar to the screen display region 304, and the given coordinates (X coordinate=15, Y coordinate=15) of the parent screen region where the copy basic screen 401 is displayed are set as the upper left vertex of the enlarged display region 901.

The enlarged display region 901 illustrated in FIG. 9 is displayed in the screen display region 304 as illustrated in FIG. 10. During the operation of the screen enlargement function, the movement buttons 902 to 905 for moving the enlarged display region 901 are displayed. By pressing (for example, by a touch operation) one of the movement buttons 902 to 905, the user can move the enlarged display region relative to the enlarged display region in the direction corresponding to the displayed movement button. For example, in a case where the user presses the right movement button 903, the enlarged display region moves to the right in the parent screen region without changing its size. The screen enlargement function ends at the time the user presses the back button 906.

Further, in a case where a pinch-in operation is performed by the user on the screen display region 304 and the enlargement magnification becomes the actual size, the screen enlargement function ends as well. Even during the operation of the screen enlargement function, the user can press the automatic size-detection setting button 603 or the free size setting button 604.

Next, the flowchart illustrated in FIG. 8 is described. The flowchart illustrated in FIG. 8 starts at the time the CPU 100 detects that the layout of the screens displayed in the screen display region 304 is changed. For example, the flowchart illustrated in FIG. 8 is started at the time the user performs a pinch-out or pinch-in operation on the screen display region 304 or performs an operation of pressing a movement button in the enlarged display region.

In S801, the CPU 100 obtains a value indicating the distance from the frame of the enlarged display region to the frame of the child screen. The value indicating the distance from the frame of the enlarged display region to the frame of the child screen can be derived in the same manner as in S501.

In S802, the CPU 100 determines whether or not the value obtained in S801 exceeds the first threshold value, as in S502. If the CPU 100 determines in S802 that the value obtained in S801 exceeds the first threshold value (YES), it is determined that the outer-frame region of the child screen is wide, and the processing proceeds to S804. If the CPU 100 determines in S802 that the value obtained in S801 is within the first threshold value (NO), it is determined that the outer-frame region of the child screen is narrow, and the processing proceeds to S803.

For example, as illustrated in FIG. 9, it is assumed that, in a state where the reading size setting screen 601 which is a child screen is displayed on the copy basic screen 401 which is a parent screen, an enlargement is performed by the screen enlargement function in the layout of these screens. In this case, the coordinates (X coordinate: Y coordinate) of the upper left vertex of the enlarged display region 901 are (15, 15), and the coordinates of the upper left vertex of the child screen region 602 are (30, 30), and thus the value indicating the distance from the frame of the enlarged display region 901 to the frame of the child screen is approximately 21.

$$\sqrt{{( 30 - 15 )}^{2} + {( 30 - 15 )}^{2}} = 21.2132$$

In this case, since 21 [MM]>14 [MM], the CPU 100 determines in S802 that the outer-frame region of the child screen is wide, and the processing proceeds to S804.

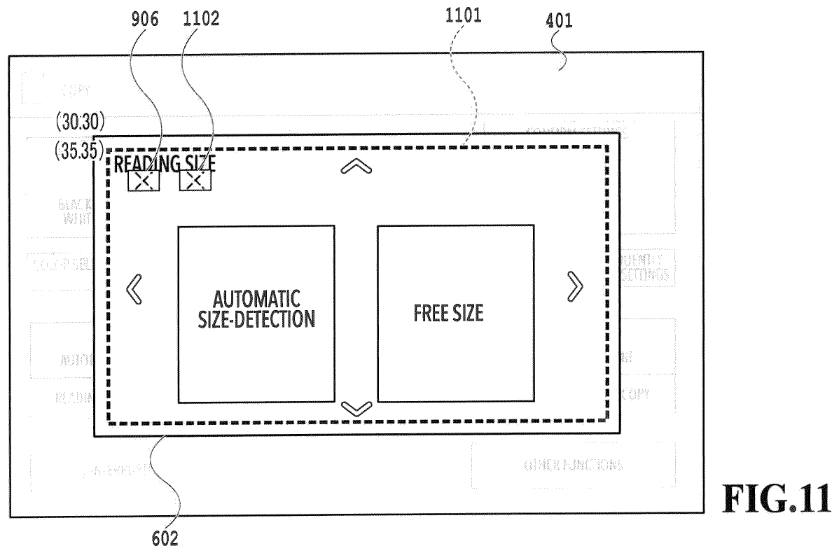

FIG. 11 is a diagram illustrating an example of a case in which the enlarged display region 901 illustrated in FIG. 9 is reduced in size relative to the parent screen region by the screen enlargement function in response to a user operation, so that the objects displayed within the enlarged display region 901 are further enlarged. The enlarged display region 1101 illustrated in FIG. 11 is in a state where the enlarged display region 901 illustrated in FIG. 9 is further reduced in size relative to the parent screen region.

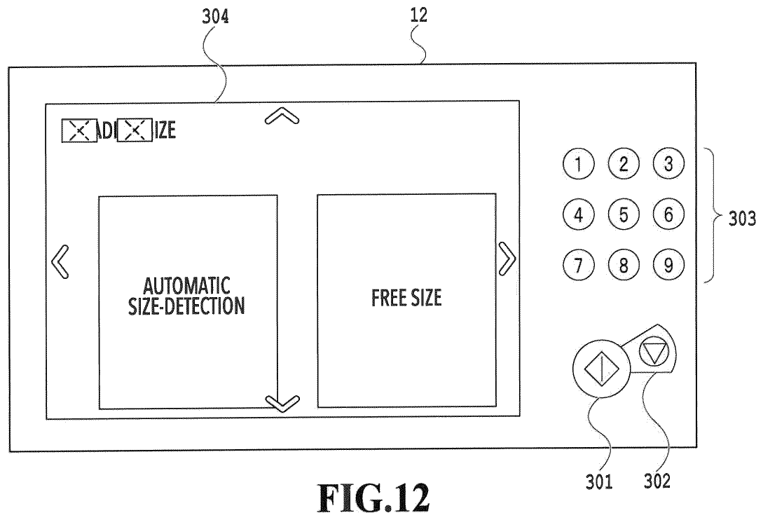

The enlarged display region 1101 is displayed in the screen display region 304 as illustrated in FIG. 12. The coordinates (X coordinate: Y coordinate) of the upper left vertex of the enlarged display region 1101 are (35, 35), and the coordinates of the upper left vertex of the child screen region 602 are (30, 30). That is, it is indicated that the frame of the child screen is located in the area outside the enlarged display region 1101. In other words, since x₂−x₁>0 and y₂−y₁>0 are not satisfied, in the situation illustrated in FIG. 11, the CPU 100 obtains 0 as the value indicating the distance from the frame of the enlarged display region to the frame of the child screen.

In this case, since 0 [MM]<14 [MM], the CPU 100 determines in S802 that the outer-frame region of the child screen is narrow, and the processing proceeds to S803.

In S803, if it is determined in S802 that the outer-frame region of the child screen is narrow, the CPU 100 displays, in the enlarged display region 1101, the close button 1102 for accepting an instruction to close the child screen. For example, in S803, the CPU 100 displays the close button 1102 on the child screen, within the enlarged display region 1101, as illustrated in FIG. 11.

In S804, the CPU 100 determines whether the outer-frame region of the child screen or the close button 1102 is pressed.

If the CPU 100 determines in S804 that the outer-frame region of the child screen or the close button 1102 is pressed (YES), the processing proceeds to S805, so that the control to close the child screen is performed in S805, and the flow illustrated in FIG. 8 ends. If the CPU 100 determines in S804 that the outer-frame region of the child screen or the close button 1102 is not pressed (NO), the processing proceeds to S806.

In S806, the CPU 100 determines whether or not the back button 906 is pressed. If the CPU 100 determines in S806 that the back button 906 is pressed (YES), the processing proceeds to S807, and if the CPU 100 determines that the back button 906 is not pressed (NO), the processing proceeds to S808.

In S807, if the close button was displayed in S803, the CPU 100 performs the control to hide the close button, starts the flow illustrated in FIG. 5, and ends the flow illustrated in FIG. 8. If it is necessary to display the close button due to a change in the screen layout, the CPU 100 performs the control to display the close button according to the flow illustrated in FIG. 5.

In S808, the CPU 100 determines whether the screen layout is further changed. For example, in S808, the CPU 100 determines whether the enlarged display region is enlarged or reduced in size relative to the parent screen region. Further, in S808, the CPU 100 determines whether any of the movement buttons 902 to 905 is pressed. That is, in S808, the CPU 100 determines whether the enlarged display region has moved.

If the CPU 100 determines in S808 that the screen layout is further changed (YES), the processing proceeds to S809, and, if the CPU 100 determines that the screen layout is not changed (NO), the processing returns to S804.

In S809, the CPU 100 determines whether or not the display magnification has become the actual size relative to the parent screen region. In S809, if the CPU 100 determines that the display magnification is at the actual size (YES), the processing proceeds to S807, and if the CPU 100 determines that the display magnification is not at the actual size (NO), the processing returns to S801.

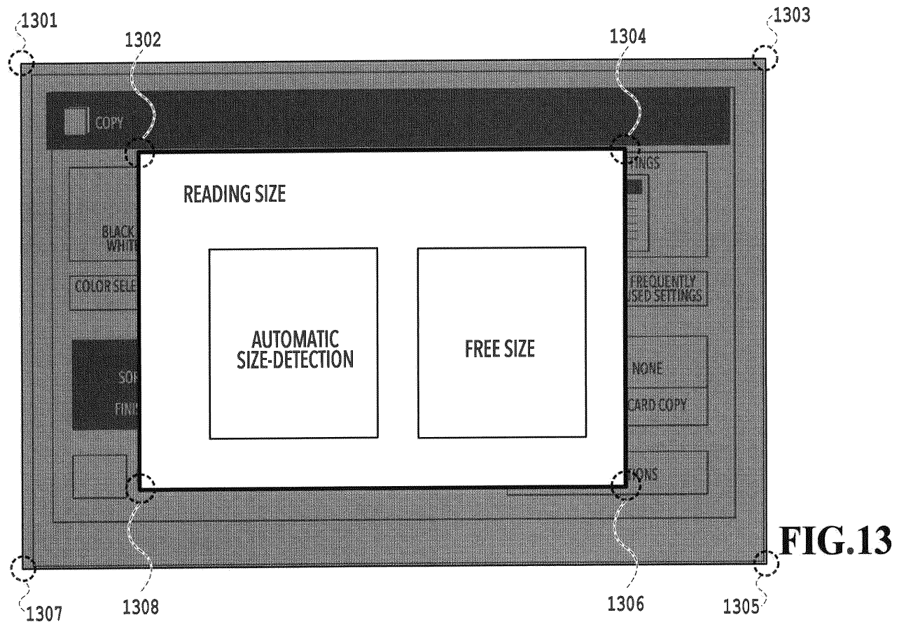

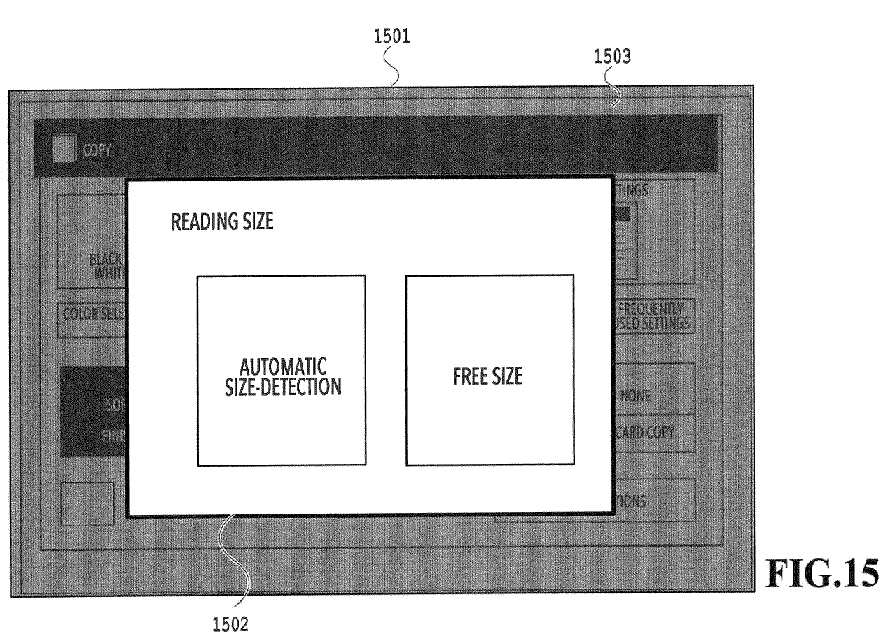

As described above, a method in which CPU 100 determines whether the outer-frame region of a child screen is wide or narrow is explained, using the example in which a value indicating the distance from the upper left vertex of the parent screen or the upper left vertex of the enlarged display region to the upper left vertex of the child screen is obtained in S501 or S801. However, there are several methods other than the above-described method for the CPU 100 to determine whether the outer-frame region of a child screen is wide or narrow. The types of determination methods are described with reference to FIG. 13 or FIG. 15.

FIG. 13 is a diagram describing a method in which the CPU 100 determines whether the outer-frame region of a child screen is wide or narrow, based on the distances from the four vertices of a parent screen region to the corresponding four vertices of a child screen region, respectively.

The CPU 100 obtains the values indicating the distances for the upper left vertices (the parent screen 1301, the child screen 1302), the upper right vertices (the parent screen 1303, the child screen 1304), the lower right vertices (the parent screen 1305, the child screen 1306), and the lower left vertices (the parent screen 1307, the child screen 1308). Then, as one example, if the value indicating the sum of the four obtained distances exceeds the second threshold value, the CPU 100 can determine that the outer-frame region of the child screen is wide. Alternatively, the CPU 100 may determine that the outer-frame region of the child screen is wide if any of the obtained values indicating the distances exceeds the first threshold value. Alternatively, the CPU 100 may determine that the outer-frame region of the child screen is narrow if any of the obtained values indicating the distances is within the first threshold value.

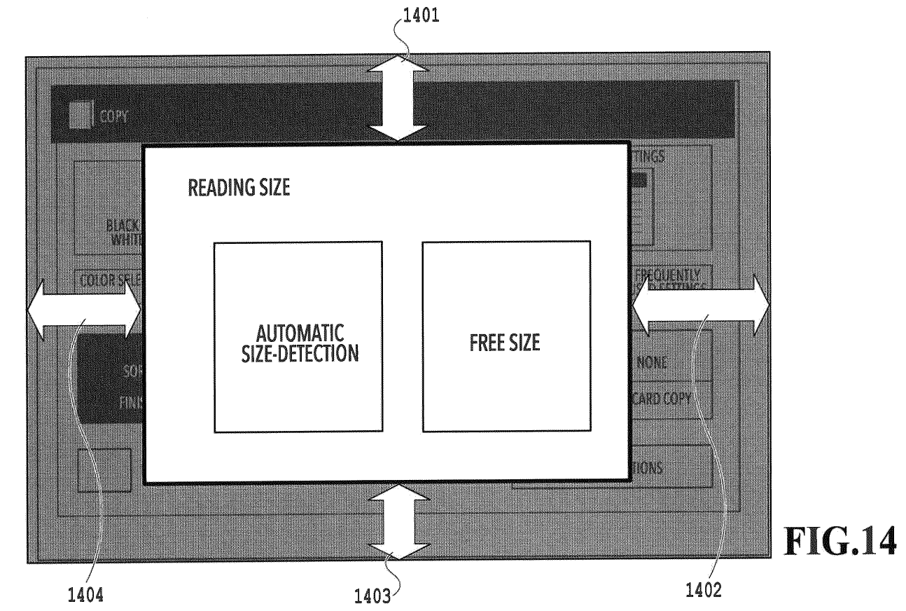

FIG. 14 is a diagram describing a method in which the CPU 100 determines whether the outer-frame region of a child screen is wide or narrow, based on the distances from the four edges of a parent screen region to the corresponding four edges of a child screen region, respectively.

The CPU 100 derives and obtains the distance (1401) from the upper edge of the parent screen to the upper edge of the child screen. For example, the CPU 100 obtains a value indicating the distance from the upper edge of the parent screen to the upper edge of the child screen along a straight line intersecting the upper edge of the parent screen and the upper edge of the child screen. Then, the CPU 100 derives and obtains the distance from the right edge of the parent screen to the right edge of the child screen (1402), the distance from the lower edge of the parent screen to the lower edge of the child screen (1403), and the distance from the left edge of the parent screen to the left edge of the child screen (1404).

As one example, if the value indicating the sum of the four obtained distances exceeds the third threshold value, the CPU 100 can determine that the outer-frame region of the child screen is wide. Alternatively, the CPU 100 may determine that the outer-frame region of the child screen is wide if any of the obtained values indicating the distances exceeds the fourth threshold value. Alternatively, the CPU 100 may determine that the outer-frame region of the child screen is narrow if any of the obtained values indicating the distances is within the fourth threshold value.

FIG. 15 is a diagram describing a method in which the CPU 100 determines whether the outer-frame region of a child screen is wide or narrow, based on the area obtained by subtracting the area of a child screen region from the area of a parent screen region.

The CPU 100 derives and obtains a value indicating the outer-frame area (1503) obtained by subtracting the area (1502) of the child screen from the area (1501) of the parent screen. Then, if the obtained value indicating the area exceeds the fifth threshold value, the CPU 100 can determine that the outer-frame region of the child screen is wide. Note that, needless to say, in S801, the parameters of the parent screen described with reference to FIG. 13 to FIG. 15 are replaced with the parameters of the enlarged display region.

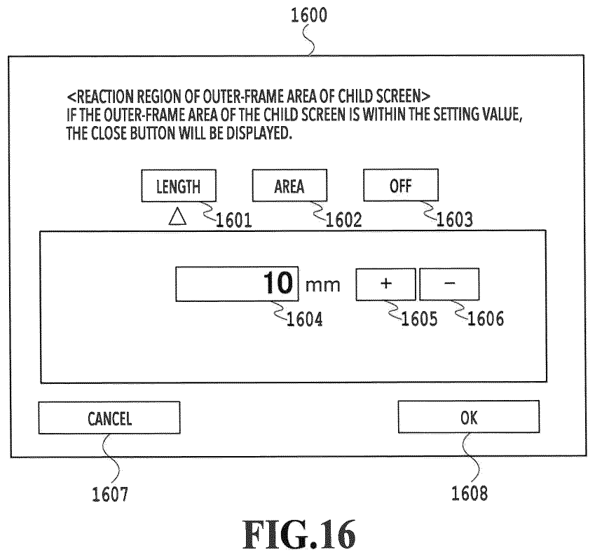

Next, an example of a setting screen that allows the user to set an any desired threshold value to be used by the CPU 100 to determine the size of the outer-frame region of a child screen in S502 or S802 is described with reference to FIG. 16 to FIG. 18.

FIG. 16 to FIG. 18 are diagrams illustrating examples of setting screens that allow the user to set a threshold value. The setting screen 1600 in FIG. 16 is a screen for setting a region (hereinafter referred to as a reaction region) that is in the outer-frame region of a child screen and can accept an instruction to close the child screen by a user's pressing operation. Here, with reference to FIG. 16, a case is assumed where a threshold value is set for a reaction region using length as a parameter. If the value representing the size of the outer-frame region of the child screen is smaller than the set threshold value of the reaction region, the image processing apparatus 1 cannot accept an instruction to close the child screen even if the user presses the outer-frame region of the child screen, and therefore must display a close button.

In the present embodiment, an example is described in which, by operating the later-described length setting button 1601 or the like, the above-described first threshold value is set as the threshold value of the reaction region. Note that the threshold value of the reaction region may be set as a value separate from the first to fifth threshold values.

The setting screen 1600 is provided with the length setting button 1601, the area setting button 1602, the OFF button 1603, the cancel button 1607, and the OK button 1608. Further, the setting screen 1600 has the threshold value display region 1604 that displays the threshold value of the reaction region, and the plus button 1605 and the minus button 1606 for adjusting the magnitude of the threshold value.

By pressing the length setting button 1601 and the area setting button 1602, the user can set the threshold value of the reaction region using either length or area as a parameter.

The user can confirm the contents set on the setting screen 1600 by pressing the OK button 1608. Further, upon detecting an operation of pressing the OK button 1608 by the user, the CPU 100 stores the setting values set on the setting screen 1600 in the selection information storage unit 207. The user can discard the setting values being set on the setting screen 1600 by pressing the cancel button 1607.

The setting screen 1600 indicates a state in which the length setting button 1601 is selected by the user. In a case where the length setting button 1601 is selected, the user can operate the numeric keypad 303 to set the threshold value of the reaction region using a parameter indicating length. The threshold value being set is displayed in the threshold value display region 1604. The user can also change the threshold value using the plus button 1605 and the minus button 1606. In a case where the threshold value of the reaction region is confirmed as 10 [MM], then in S502 or S802, the CPU 100 determines whether or not the value indicating the distance from the upper left vertex of the parent screen to the upper left vertex of the child screen exceeds 10 [MM].

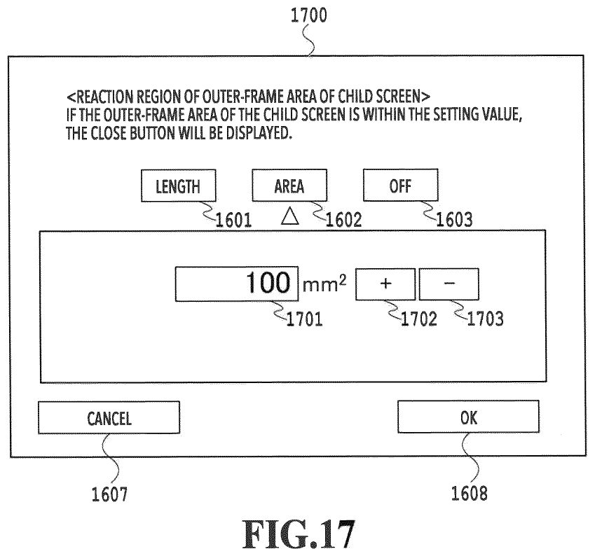

FIG. 17 is a diagram illustrating the setting screen 1700 that is displayed in a case where the area setting button 1602 on the setting screen 1600 is selected by the user.

In a case where the area setting button 1602 is selected, the user can operate the numeric keypad 303 to set the threshold value of the reaction region using a parameter indicating area. The threshold value being set is displayed in the area display region 1701. The user can also change the threshold value using the plus button 1702 and the minus button 1703. In a case where the threshold value of the reaction region is confirmed as 100 [MM], then in S502 or S802, the CPU 100 determines whether or not the area of the rectangle with a diagonal line connecting the upper left vertex of the parent screen and the upper left vertex of the child screen exceeds 100 [MM].

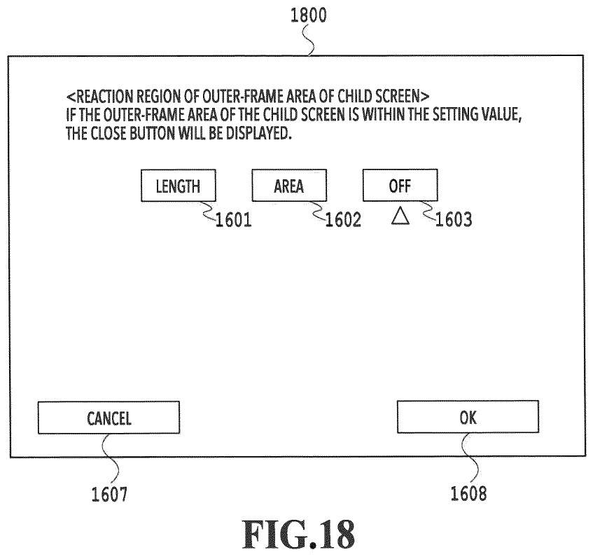

FIG. 18 is a diagram illustrating the setting screen 1800 that is displayed in a case where the OFF button 1603 on the setting screen 1600 is selected by the user. In a case where the OFF button 1603 is selected, the image processing apparatus 1 performs the control to display a close button without reacting to pressing on the outer-frame region of the child screen by the user.

According to the present embodiment, even in a case where the outer-frame region of a child screen is narrow and it is difficult to accept a user's pressing operation on the outer-frame region of the child screen, a close button for closing the child screen is displayed, thereby providing the user with a method of closing the child screen. Further, the close button is displayed at a predetermined position on the child screen. This can prevent the user from making an erroneous operation, and can reduce the occurrence of a situation where the user is unable to close the screen. Therefore, the usability in operating the screen can be improved.

### OTHER EMBODIMENTS

In the description of the embodiment above, the CPU 100 controls so as to provide the user with either a method of closing a child screen by pressing a close button or a method of closing the child screen by pressing the outer-frame region of the child screen, as an example. In the present embodiment, even in a situation where the close button is displayed, the control to accept a user's pressing operation on the outer-frame region of the child screen may be performed, so that the CPU 100 performs the control of closing the child screen in S505 or S805. That is, for a child screen on which the close button was displayed in S503 or S803, the CPU 100 may control the child screen to be closed not only in response to a pressing operation on the close button, but also in response to a user's pressing operation on the outer-frame region of the child screen.

In this case, it can be implemented by setting the threshold value used to determine whether the outer-frame region of the child screen is wide or narrow and the threshold value of the reaction region to different values. For example, a description is given of a case in which a value indicating the distance from the frame of a parent screen to the frame of a child screen is obtained as the value representing the size of the outer-frame region. Assume a case where the CPU 100 obtains 10 [MM] as the value representing the size of the outer-frame region of the child screen, the first threshold value is 15 [MM], and the threshold value of the reaction region is 5 [MM]. In this case, since the value representing the size of the outer-frame region is within the first threshold value, the CPU 100 displays the close button. Then, since the value representing the size of the outer-frame region exceeds the threshold value of the reaction region, the CPU 100 can accept a user's operation performed on the outer-frame region of the child screen. Therefore, the CPU 100 can perform control so as to close the child screen in response to either a pressing operation on the close button or a user's pressing operation on the outer-frame region of the child screen.

In the present embodiment, a certain region is provided in the child screen in a direction extending inward from the frame of the child screen, and a certain region is provided in the outer-frame region of the child screen in a direction extending outward from the frame of the child screen. Further, the CPU 100 can display the close button within these certain regions (within the restricted regions). Even though an operation from the user is accepted in these restricted regions, the CPU 100 may control so as not to execute the processing based on a pressing operation or the like on any button other than the close button. In this way, by providing a restricted region in which user's operations on buttons other than the close button are restricted, it is possible to reduce malfunctions caused by erroneous operations, such as at the time the user accidentally presses another button in an attempt to perform an operation for closing a child screen.

In the above-described embodiment, the CPU 100 may display another screen superimposed on a child screen. For example, in a case where the paper selection screen 701 which is a child screen is displayed on the copy basic screen 401 which is a parent screen, the CPU 100 may further display a grandchild screen on the paper selection screen 701 which is a child screen. In such a case, in a method of determining whether the outer-frame region of the grandchild screen is wide or narrow, it is possible to use a value for a vertex or edge that configures the copy basic screen 401 which is the parent screen, and a value for a vertex or edge that configures the grandchild screen.

In the above embodiment, the example is described in which the CPU 100 places and displays the reading size setting screen 601 or the paper selection screen 701 on the copy basic screen 401 so that the reading size setting screen 601 or the paper selection screen 701 is embedded within the copy basic screen 401; however, there is no such limitation. For example, the CPU 100 may place and display the reading size setting screen 601 or the paper selection screen 701 on the copy basic screen 401 so that the reading size setting screen 601 or the paper selection screen 701 overlaps with part of the copy basic screen 401. For example, CPU 100 can place and display a child screen on a parent screen such that the parent screen has a portion that does not overlap with the child screen, and the child screen has a portion that does not overlap with the parent screen.

In this case, any of the methods described in the above embodiment can be employed as the method for obtaining information representing the size of the outer-frame region of the child screen. As an example, the CPU 100 can obtain a value indicating the distance from one of the vertices of a rectangular parent screen to the corresponding vertex of a rectangular child screen as the information representing the size of the outer-frame region of the child screen. Then, based on the obtained information, the CPU 100 determines whether the portion of the parent screen that does not overlap with the child screen is wide or narrow, and performs the control as to whether or not to display a button for closing the child screen.

Further, also in this case, as in the above-described embodiment, the CPU 100 can obtain information representing the size of the portion where the enlarged display region and the child screen do not overlap in a situation where the screen layout has been changed, and determine whether that portion is wide or narrow.

Alternatively, the CPU 100 may place and display a child screen on a parent screen such that the child screen covers the entire parent screen. For example, the CPU 100 can place and display a child screen, which is the same size as a parent screen or larger than the parent screen, on the parent screen such that the child screen covers the parent screen. In this case, since there is no outer-frame region of the child screen, the CPU 100 can display a button for closing the child screen at such a position as illustrated in FIG. 7 or FIG. 11 in the portion where the parent screen and the child screen overlap. Further, also in this case, as in the above-described embodiment, the CPU 100 can display the button for closing the child screen at such a position as illustrated in FIG. 7 or FIG. 11 in a situation where the screen layout has been changed.

In the present embodiment, these cases are described using the examples in which the parent screen region is displayed to fit the screen display region 304; however, there is no such limitation. For example, based on the coordinate axes in the above-described embodiment, a basic display region is defined which is a rectangular region whose upper left vertex is the reference point. Then, a parent screen region and a child screen region may be defined within the basic display region.

The CPU 100 may display the basic display region so as to fit the screen display region 304, and display the parent screen and child screen within the basic display region. In this case also, any of the methods described in the above embodiment can be employed as the method for obtaining information representing the size of the portion of the basic display region that does not overlap with the child screen. As an example, the CPU 100 can obtain a value indicating the distance from one of the vertices of the basic display region to the corresponding vertex of a rectangular child screen as the information representing the size of the portion of the basic display region that does not overlap with the child screen. Further, even in a case where the screen layout is changed in this case, the CPU 100 can obtain the information representing the size of the region where the enlarged display region and the child screen do not overlap, using a method described in the above embodiment.

Although a case in which the present disclosure is applied to an image processing apparatus is described in the above embodiment, the present disclosure is also applicable to control related to setting screens of a personal computer (PC), a tablet-type terminal, a smartphone, various types of electronic devices, or home appliances.

Note that, needless to say, the configurations and contents of the various data described above are not limited as such, and the data may have various configurations and contents depending on the application and purpose. Further, although a description is given about one embodiment, it is possible that the present disclosure is provided in such a form of implementation as a system, an apparatus, a method, a program, or a storage medium, for example. Specifically, application to a system configured with multiple devices and application to an apparatus constituted by a single device are also possible. Configurations with combinations of the respective embodiments are also included in the present disclosure.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-164393, filed Sep. 20, 2024, which is hereby incorporated by reference herein in its entirety.

What is claimed is:

1. An information processing apparatus comprising:
a first display control unit configured to perform control to display a first screen and a second screen arranged so as to overlap with the first screen on a display unit;
an obtaining unit configured to obtain information representing a size of a region of the first screen that does not overlap with the second screen, in a case where the second screen is displayed by the first display control unit;
a second display control unit configured to perform control to display a first object for closing the second screen, in a case where the information satisfies a predetermined condition; and
a control unit configured to perform control to close the second screen, in a case where the first object displayed by the second display control unit is operated by a user.

2. The information processing apparatus according to claim 1,
wherein the obtaining unit obtains a value representing the size of the region of the first screen that does not overlap with the second screen, and
wherein the case where the predetermined condition is satisfied is a case where the value obtained by the obtaining unit is within a predetermined threshold value.

3. The information processing apparatus according to claim 1,
wherein the obtaining unit obtains information indicating a distance from one of the vertices of a rectangular region representing the first screen to the corresponding vertex of a rectangular region representing the second screen.

4. The information processing apparatus according to claim 1,
wherein the obtaining unit obtains information indicating distances from all vertices of a rectangular region representing the first screen to the corresponding vertices of a rectangular region representing the second screen, respectively.

5. The information processing apparatus according to claim 1,
wherein the obtaining unit obtains information indicating distances from all edges of a rectangular region representing the first screen to the corresponding edges of a rectangular region representing the second screen, respectively.

6. The information processing apparatus according to claim 1,
wherein the obtaining unit obtains information indicating an area obtained by subtracting an area of a rectangular region representing the second screen from an area of a rectangular region representing the first screen.

7. The information processing apparatus according to claim 1,
wherein, in a case where the information does not satisfy the predetermined condition, the second display control unit performs control not to display the first object.

8. The information processing apparatus according to claim 1 further comprising
an acceptance control unit configured to perform control to accept a user's operation on the region of the first screen that does not overlap with the second screen,
wherein the control unit further performs control to close the second screen in a case where the acceptance control unit accepts the user's operation on the region of the first screen that does not overlap with the second screen.

9. The information processing apparatus according to claim 8,
wherein the acceptance control unit performs control to enable acceptance of the user's operation on the region of the first screen that does not overlap with the second screen in a case where the information representing the size of the region of the first screen that does not overlap with the second screen does not satisfy the predetermined condition, and
performs control not to accept the user's operation on the region in a case where the information satisfies the predetermined condition.

10. The information processing apparatus according to claim 1,
wherein the second display control unit performs control to display the first object on the second screen, at a position that is a certain distance or more away from a second object displayed on the second screen.

11. The information processing apparatus according to claim 1,
wherein a restricted region is provided on the second screen within a certain region from a boundary line that separates the second screen and the outer frame region of the second screen, the restricted region being configured not to accept a user's operation on a second object, which is displayed on the second screen other than the first object, and
wherein the second display control unit performs control to display the first object in the restricted region.

12. The information processing apparatus according to claim 2 further comprising
a setting unit configured to enable the user to set the predetermined threshold value,
wherein the setting unit enables setting of the predetermined threshold value using a parameter indicating length or area.

13. A control method of an information processing apparatus, the control method comprising:
controlling to display a first screen and a second screen arranged so as to overlap with the first screen on a display unit;
obtaining information representing a size of a region of the first screen that does not overlap with the second screen, in a case where the second screen is displayed by the controlling to display the first screen and the second screen;
controlling to display a first object for closing the second screen, in a case where the information satisfies a predetermined condition; and
controlling to close the second screen, in a case where the first object displayed by the controlling to display the first object is operated by a user.

14. A non-transitory computer-readable storage medium storing a program for causing an information processing apparatus to execute a method, the method comprising:
controlling to display a first screen and a second screen arranged so as to overlap with the first screen on a display unit;
obtaining information representing a size of a region of the first screen that does not overlap with the second screen, in a case where the second screen is displayed by the controlling to display the first screen and the second screen;
controlling to display a first object for closing the second screen, in a case where the information satisfies a predetermined condition; and
controlling to close the second screen, in a case where the first object displayed by the controlling to display the first object is operated by a user.
